(19) United States
(12) Patent Application Publication
(10) Pub. No.: US 2025/0153495 A1
(43) Pub. Date: May 15, 2025

(54) LIQUID DROPLET JETTING APPARATUS AND MANUFACTURING METHOD OF PRINTED ARTICLE

(71) Applicant: FUJIFILM Corporation, Tokyo (JP)

(72) Inventor: Tadashi KYOSO, Kanagawa (JP)

(73) Assignee: FUJIFILM Corporation, Tokyo (JP)

(21) Appl. No.: 19/021,162

(22) Filed: Jan. 15, 2025

Related U.S. Application Data
(63) Continuation of application No. PCT/JP2023/022884, filed on Jun. 21, 2023.

(30) Foreign Application Priority Data
Aug. 9, 2022 (JP) 2022-126958

(51) Int. Cl. B41J 29/00; B41J 2/18; B41J 11/00

(52) U.S. Cl. CPC B41J 29/00; B41J 2/18; B41J 11/008

(57) ABSTRACT

Provided are a liquid droplet jetting apparatus and a manufacturing method of a printed article that maintain a good jetting state even in a case in which a low-density gas is used. A liquid droplet jetting apparatus includes: a liquid droplet jetting head that jets a liquid; a relative movement mechanism that moves a substrate and the liquid droplet jetting head relative to each other; and a control device that moves the substrate and the liquid droplet jetting head relative to each other and causes the liquid droplet jetting head to jet the liquid, to print an image on the substrate, in which a low-density gas having a lower density than air is contained between the liquid droplet jetting head and the substrate, the liquid droplet jetting head includes a circulation flow channel for circulating the liquid, and the control device circulates the liquid at least during printing.

### CROSS-REFERENCE TO RELATED APPLICATIONS

The present application is a Continuation of PCT International Application No. PCT/JP2023/022884 filed on Jun. 21, 2023 claiming priority under 35 U.S.C § 119(a) to Japanese Patent Application No. 2022-126958 filed on Aug. 9, 2022. Each of the above applications is hereby expressly incorporated by reference, in its entirety, into the present application.

### BACKGROUND OF THE INVENTION

### 1. Field of the Invention

The present invention relates to a liquid droplet jetting apparatus and a manufacturing method of a printed article, and particularly relates to a technique of stabilizing a jetting state.

### 2. Description of the Related Art

As ink jet liquid droplets become finer (for example, 3 pL or less per droplet), an ink jet head is strongly affected by air resistance between the ink jet head and a substrate. Therefore, in a case in which a distance between the ink jet head and the substrate is wide, a defect occurs in that the liquid droplets do not land onto the substrate or do not land onto an appropriate place due to an influence of a disturbance such as wind even in a case in which the liquid droplets land onto the substrate.

As a technique of reducing air resistance between the ink jet head and the substrate, JP7068846B and JP2018-12343A disclose that a printing portion is replaced with helium.

### SUMMARY OF THE INVENTION

However, the techniques disclosed in JP7068846B and JP2018-12343A have a problem in that a solvent component in the ink is evaporated and the jetting state is deteriorated.

The present invention has been made in view of such circumstances, and an object of the present invention is to provide a liquid droplet jetting apparatus and a manufacturing method of a printed article that maintain a good jetting state even in a low-density gas environment.

In order to achieve the above-described object, a first aspect of the present disclosure provides a liquid droplet jetting apparatus comprising: a liquid droplet jetting head that jets a liquid; a relative movement mechanism that moves a substrate and the liquid droplet jetting head relative to each other; and a control device that moves the substrate and the liquid droplet jetting head relative to each other and causes the liquid droplet jetting head to jet the liquid, to print an image on the substrate, in which a low-density gas having a lower density than air is contained between the liquid droplet jetting head and the substrate, the liquid droplet jetting head includes a circulation flow channel inside the liquid droplet jetting head, and the control device circulates the liquid through the circulation flow channel at least during printing. According to the present aspect, a good jetting state can be maintained.

A second aspect of the present disclosure provides the liquid droplet jetting apparatus according to the first aspect, in which it is preferable that the liquid droplet jetting head includes a jetting element including a nozzle, a pressure chamber, and a jetting energy generation element, and the circulation flow channel includes a supply flow channel for supplying the liquid to the jetting element and a recovery flow channel for recovering the liquid from the jetting element.

A third aspect of the present disclosure provides the liquid droplet jetting apparatus according to the first or second aspect, in which it is preferable that the control device sets a circulation amount of the liquid during the printing to be greater than a circulation amount of the liquid during non-printing.

A fourth aspect of the present disclosure provides the liquid droplet jetting apparatus according to any one of the first to third aspects, in which it is preferable that the control device stops the circulation of the liquid during non-printing.

A fifth aspect of the present disclosure provides the liquid droplet jetting apparatus according to any one of the first to fourth aspects, in which it is preferable that the control device applies vibration to a non-jetting nozzle during the printing to an extent that the liquid droplet is not jetted.

A sixth aspect of the present disclosure provides the liquid droplet jetting apparatus according to any one of the first to fifth aspects, in which it is preferable that the liquid droplet jetting apparatus further comprises: a supply mechanism that supplies the low-density gas between the liquid droplet jetting head and the substrate, and the supply mechanism stops the supply of the low-density gas during the printing.

A seventh aspect of the present disclosure provides the liquid droplet jetting apparatus according to any one of the first to sixth aspects, in which it is preferable that the liquid droplet jetting apparatus further comprises: a chamber that internally houses the liquid droplet jetting head and the relative movement mechanism, and the chamber has a carry-in slit through which the substrate is carried in and a carry-out slit through which the substrate is carried out, the carry-in slit and the carry-out slit being each provided with an openable and closable shutter.

An eighth aspect of the present disclosure provides the liquid droplet jetting apparatus according to the seventh aspect, in which it is preferable that the liquid contains a solvent, and the solvent is disposed inside the chamber in an open state.

A ninth aspect of the present disclosure provides the liquid droplet jetting apparatus according to any one of the first to sixth aspects, in which it is preferable that the liquid contains a solvent, and the supply mechanism supplies the low-density gas containing a gas of the solvent.

A tenth aspect of the present disclosure provides the liquid droplet jetting apparatus according to any one of the first to ninth aspects, in which it is preferable that the liquid is an aqueous ink containing water as a solvent.

In order to achieve the above-described object, an eleventh aspect of the present disclosure provides a manufacturing method of a printed article, the manufacturing method comprising: supplying a low-density gas having a lower density than air between a liquid droplet jetting head and a substrate; moving the substrate and the liquid droplet jetting head relative to each other and causing the liquid droplet jetting head to jet a liquid, to print an image on the substrate; and circulating the liquid through a circulation flow channel of the liquid droplet jetting head at least during printing. According to the present aspect, a good jetting state can be maintained.

According to the aspects of the present invention, a good jetting state can be maintained even in a low-density gas environment.

### BRIEF DESCRIPTION OF THE DRAWINGS

FIG. 1 is a side view showing an overview of a printing apparatus.

FIG. 2 is a plan view showing the overview of the printing apparatus.

FIG. 3 is a perspective view of a liquid droplet jetting head.

FIG. 4 is a plan perspective view showing a structure example of a silicon die.

FIG. 5 is a cross-sectional view taken along line 5-5 of FIG. 4.

FIG. 6 is a cross-sectional view taken along line 5-5 of FIG. 4 according to a modification example.

FIG. 7 is a schematic diagram showing a configuration example of a printing apparatus according to a second embodiment.

FIG. 8 is a schematic diagram showing a configuration example of a printing apparatus according to a third embodiment.

FIG. 9 is a schematic diagram showing a configuration example of a printing apparatus according to a fourth embodiment.

FIG. 10 is a schematic diagram showing a configuration example of a printing apparatus according to a fifth embodiment.

FIG. 11 is a schematic diagram showing a configuration example of a printing apparatus according to a sixth embodiment.

FIG. 12 is a block diagram showing an electric configuration of the printing apparatus.

### DESCRIPTION OF THE PREFERRED EMBODIMENTS

Hereinafter, a detailed description of preferred embodiments of the present invention will be made with reference to the accompanying drawings. In the description of the respective embodiments, illustration and description of parts common to the other embodiments will be omitted as appropriate.

### Overview of Printing Apparatus: First Embodiment

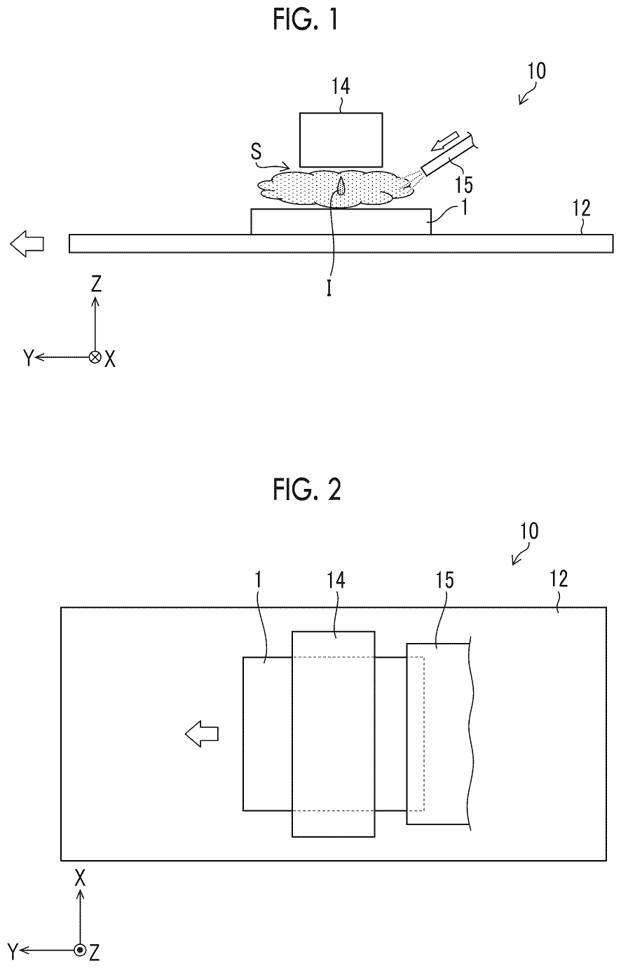

FIG. 1 is a side view showing an overview of a printing apparatus 10, and FIG. 2 is a plan view showing the overview of the printing apparatus 10. The printing apparatus 10 is a liquid droplet jetting apparatus that prints an image on a substrate 1.

The printing apparatus 10 comprises a transport device 12, a liquid droplet jetting head 14, and a helium supply mechanism 15. The transport device 12 is a relative movement mechanism that moves the substrate 1 and the liquid droplet jetting head 14 relative to each other by transporting the substrate 1 in a Y direction that is a horizontal direction. The liquid droplet jetting head 14 is an ink jet head that jets liquid droplets I of an aqueous ink (an example of a “liquid”) containing water as a solvent by using an ink jet method.

The printing apparatus 10 jets the liquid droplets I of the ink from the liquid droplet jetting head 14 onto a recording surface of the substrate 1 transported in the Y direction by the transport device 12, to form an image. The substrate 1 is, for example, a print substrate, and the ink is, for example, a conductive ink containing a conductive material. The printing apparatus 10 may comprise a head carriage that moves the liquid droplet jetting head 14 in an X direction.

The helium supply mechanism 15 comprises a helium tank (not shown) in which a helium gas (hereinafter, referred to as helium), which is an example of a low-density gas having a lower density than air, is stored. The helium supply mechanism 15 supplies the helium from the helium tank to a space S between the liquid droplet jetting head 14 and the substrate 1. As a result, the space S mainly contains the helium. Among the gases present in the space S, it is preferable that 50% or more are the low-density gases, it is more preferable that 90% or more are the low-density gases, and it is still more preferable that 99% or more are the low-density gases.

As described above, by changing the gas in the space S from air in which nitrogen is the main component to the low-density gas including hydrogen and/or helium, a density ρ of the gas can be reduced, and the Reynolds number Re can be reduced. As the Reynolds number Re is decreased, the flow is laminar, and at least the pressure resistance due to the peeling can be reduced.

As a result, since the air resistance of the liquid droplets I is reduced, the printing apparatus 10 can maintain a good jetting state and can cause the liquid droplets I to land onto the substrate 1 with high accuracy even in a case in which a distance between the liquid droplet jetting head 14 and the substrate 1 is relatively large, such as 5 mm to 30 mm. In a general printing apparatus, a distance between a liquid droplet jetting head and a substrate for accurate landing is about 0.5 mm to 2 mm.

It should be noted that, in a case in which the ink is jetted from the liquid droplet jetting head 14, the printing apparatus 10 stops the inflow (supply) of the helium from the helium supply mechanism 15. As a result, it is possible to suppress the jetting disturbance caused by the flow of the gas. This is because the jetting using the ink jet method is extremely weak with respect to the flow of the gas, and thus a jetting direction of the liquid droplets I is easily bent. The printing apparatus 10 may supply an amount of the helium from the helium supply mechanism 15 such that the liquid droplets I are not affected by the flow of the helium.

The supply of the helium from the helium supply mechanism 15 may be stopped during the printing. The term “during the printing” includes at least a state in which the liquid droplet jetting head 14 and the substrate 1 face each other. The printing apparatus 10 performs the printing by applying an ink with the liquid droplet jetting head 14 while transporting the substrate 1 via the transport device 12. In the present embodiment, a period from the substrate 1 having reached a position facing the liquid droplet jetting head 14 to the substrate 1 having passed through the position facing the liquid droplet jetting head 14 is a period during the printing, and other periods are a period during the non-printing.

### [Configuration of Liquid Droplet Jetting Head]

In a case in which the air in the space S is replaced with the helium, there is a concern that the jetting may be deteriorated due to the evaporation of the solvent of the ink. In the present embodiment, even in a case in which the solvent is evaporated from the ink, in order to stabilize the jetting state, a liquid droplet jetting head in which the ink circulates to the periphery of the nozzle is used.

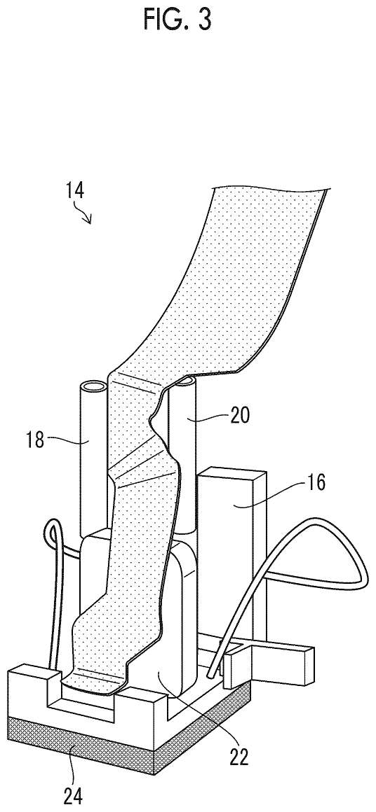

FIG. 3 is a perspective view of the liquid droplet jetting head 14. The liquid droplet jetting head 14 comprises an L-shaped bracket 16, a silicon die 24, an ink supply channel 18, an ink recovery channel 20, and a filter housing 22.

The L-shaped bracket 16 is a member for fixing the liquid droplet jetting head 14 to a head support member (not shown).

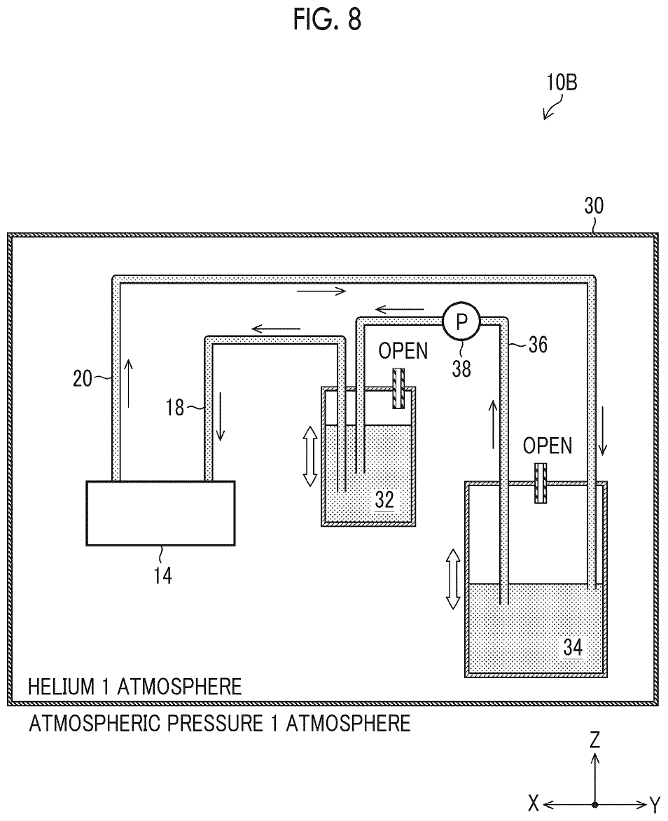

The ink supply channel 18 is connected to an upper ink tank 32 (see FIG. 8). The ink supply channel 18 supplies the ink from the upper ink tank 32 to the liquid droplet jetting head 14. The ink recovery channel 20 is connected to a lower ink tank 34 (see FIG. 8). The ink recovery channel 20 recovers the ink supplied to the liquid droplet jetting head 14 to the lower ink tank 34.

The filter housing 22 houses a filter for removing foreign substances and the like contained in the ink inside the liquid droplet jetting head 14.

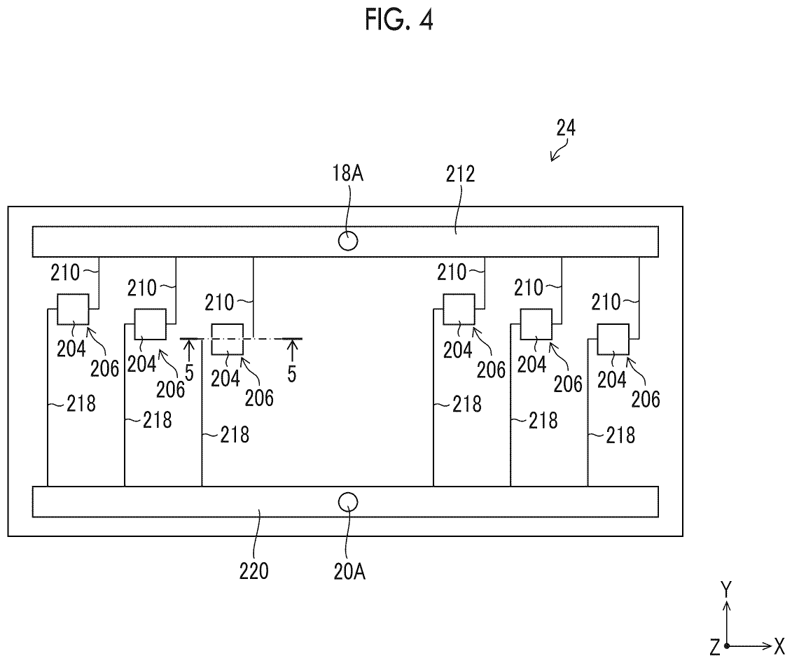

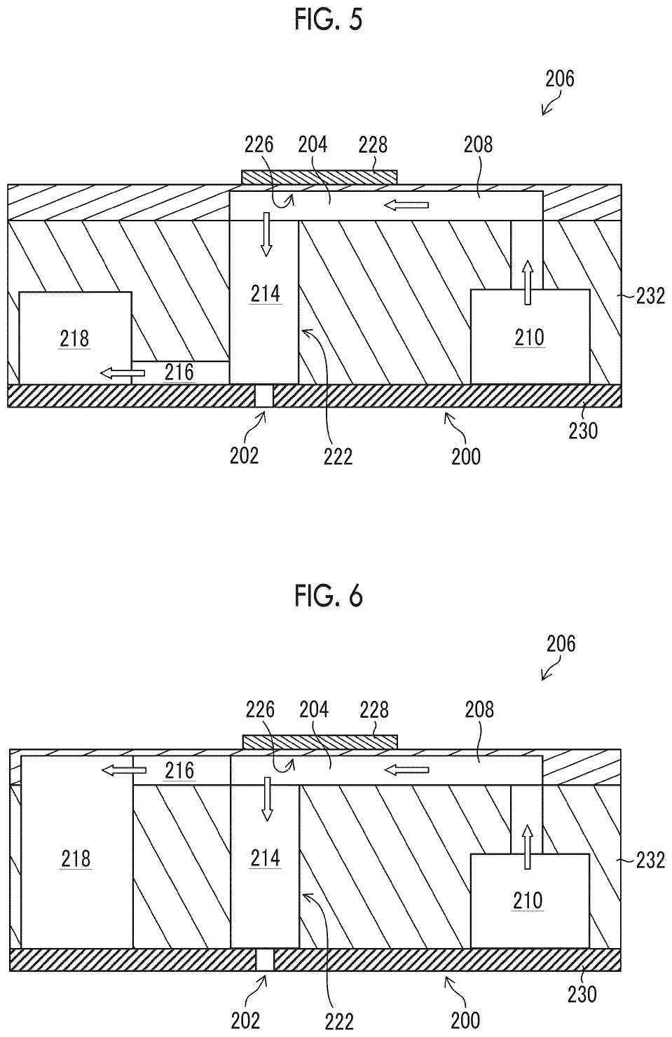

The silicon die 24 comprises a nozzle surface 200 (see FIG. 5) facing the substrate 1 transported by the transport device 12. FIG. 4 is a plan perspective view showing a structure example of the silicon die 24, and FIG. 5 is a cross-sectional view taken along line 5-5 of FIG. 4.

The silicon die 24 includes a nozzle plate 230 in which a nozzle 202, which is an outlet for ink droplets, is formed, and a flow channel plate 232 in which a flow channel for the ink is formed. The nozzle plate 230 and the flow channel plate 232 are laminated and joined. The flow channel plate 232 has a structure in which one or a plurality of substrates are laminated. The nozzle plate 230 and the flow channel plate 232 can be processed into a required shape through a semiconductor manufacturing process with silicon as a material.

The silicon die 24 comprises a plurality of nozzles 202 on the nozzle surface 200 that is a bottom surface. Further, each of a plurality of ink chamber units 206, which consists of a pressure chamber 204 or the like provided to correspond to each nozzle 202, is two-dimensionally disposed in a regular arrangement pattern. This achieves a substantially high density of the nozzle intervals projected to be arranged along the X direction.

The pressure chamber 204 communicates with a supply tributary 210 via a supply stop 208, and each supply tributary 210 communicates with a common flow channel 212. Further, a descender 214 that communicates with each pressure chamber 204 communicates with a circulation common flow channel 220 via an ink circulation channel 216 and a recovery tributary 218. An ink supply port 18A and an ink discharge port 20A are provided in the silicon die 24. The ink supply channel 18 (see FIG. 3) is connected to the ink supply port 18A. The ink recovery channel 20 (see FIG. 3) is connected to the ink discharge port 20A.

As described above, the ink supply port 18A and the ink discharge port 20A of the silicon die 24 are configured to communicate with each other via the common flow channel 212, the supply tributary 210, the supply stop 208, the pressure chamber 204, the descender 214, the ink circulation channel 216, the recovery tributary 218, and the circulation common flow channel 220.

Accordingly, the ink supplied from the ink supply channel 18 to the ink supply port 18A flows through the common flow channel 212, the supply tributary 210, the supply stop 208, the pressure chamber 204, and the descender 214, a part of the ink is jetted from each nozzle 202, and the remaining ink is discharged from the ink discharge port 20A to the ink recovery channel 20 via the ink circulation channel 216, the recovery tributary 218, and the circulation common flow channel 220.

In addition, a piezo actuator 228 comprising an individual electrode (not shown) is joined to a vibration plate 226 constituting a top surface of the pressure chamber 204 and serving as a common electrode. In a case in which a predetermined voltage is applied to the individual electrode, the piezo actuator 228 is deformed in a direction in which the pressure chamber 204 is contracted. As a result, the ink is jetted from the nozzle 202. Then, the piezo actuator 228 is deformed in a direction in which the pressure chamber 204 is expanded. As a result, a new ink is supplied from the common flow channel 212 to the pressure chamber 204 through the supply tributary 210 and the supply stop 208.

Here, the piezo actuator 228 is applied as a jetting energy generation element of the ink jetted from the nozzle 202, but a thermal method can also be applied in which the pressure chamber 204 comprises a heater and the ink is jetted by using a pressure of film boiling caused by heating the heater.

As described above, the liquid droplet jetting head 14 includes a jetting element 222 including the nozzle 202, the pressure chamber 204, and the piezo actuator 228. The liquid droplet jetting head 14 includes the supply tributary 210 (an example of a “supply flow channel”) that supplies the ink to the jetting element 222, and the recovery tributary 218 (an example of a “recovery flow channel”) that recovers the ink from the jetting element 222. The supply tributary 210 and the recovery tributary 218 constitute a “circulation flow channel”.

It is preferable that the ink circulation channel 216 is provided in the vicinity of the nozzle 202. Herein, the ink circulation channel 216 is provided in a region that communicates with the descender 214, that is, a region of the flow channel plate 232 that is in contact with the nozzle plate 230. Accordingly, since the ink circulates in the vicinity of the nozzle 202, the ink in the nozzle 202 is prevented from being thickened, and the ink can be stably jetted.

FIG. 6 is a cross-sectional view taken along line 5-5 of FIG. 4 according to a modification example. In the modification example shown in FIG. 6, the ink circulation channel 216 is provided in a region that communicates with the descender 214 and that is in contact with the vibration plate 226. Even in a case of such a configuration, the effect is lower than the effect of the ink chamber unit 206 shown in FIG. 5, but the ink can circulate in the vicinity of the nozzle 202, and the ink can be stably jetted.

As described above, by using the liquid droplet jetting head 14 in which the ink circulates, even though the solvent of the ink is evaporated from the nozzle 202 in an environment in which the partial pressure of the main solvent of the ink is low, a new ink is supplied to the ink chamber unit 206 one after another. Therefore, it is possible to maintain a stable jetting state even in a helium environment in which the partial pressure of the solvent is 0 atmospheres. In particular, since water has a high vapor pressure and easily is evaporated, it is difficult to use the aqueous ink in the printing apparatus using the helium, but the aqueous ink can be used by the ink circulation. In addition, the heat generated by the liquid droplet jetting head 14 can be taken out to the outside through the ink by circulating the ink with respect to the insufficient heat radiation of the liquid droplet jetting head 14.

It is desirable to change an ink circulation amount between during the printing and during the non-printing of the printing apparatus 10. Since it is desirable that a fresh ink always flows into the ink chamber unit 206 during the printing, the ink circulation amount is increased as much as possible. As for the ink circulation amount during the printing, in a case of the same ink, it is desirable to circulate the ink at the ink circulation amount of 2 times or more, more desirable to circulate the ink at the ink circulation amount of 3 times or more, and still more desirable to circulate the ink at the ink circulation amount of 5 times or more, with respect to the ink circulation amount of general ink circulation of 1000 pL/sec to 10000 pL/sec per nozzle.

On the other hand, since it is desired to suppress ink evaporation as much as possible during the non-printing, it is desirable to reduce the ink circulation amount during the non-printing to a level at which the nozzle 202 is not solidified by the ink evaporation, as compared to the ink circulation amount during the printing. For example, in the helium environment, the clogging of the nozzle 202 does not occur even with the aqueous ink for a few minutes, and, in this case, stopping the ink circulation for a short time can also be selected as a method of suppressing the solvent evaporation. That is, during the non-printing, circulation stop→several minutes later→circulation→several minutes later→circulation stop . . . may be repeated. In this manner, by stopping the ink circulation at an unnecessary timing or reducing the ink circulation amount, unnecessary ink evaporation can be reduced.

In addition, in order to suppress an adverse effect on the jetting due to the evaporation of the ink solvent, it is desirable to apply vibration to a non-jetting nozzle that does not jet the ink during the printing from the piezo actuator 228 to the extent that the ink is not jetted (so-called meniscus oscillation). By combining this with the ink circulation, a fresh ink can be fed to the nozzle 202, so that an increase in the ink viscosity of the nozzle 202 can be further suppressed, and more stable jetting can be achieved.

### Printing Apparatus Using Chamber: Second Embodiment

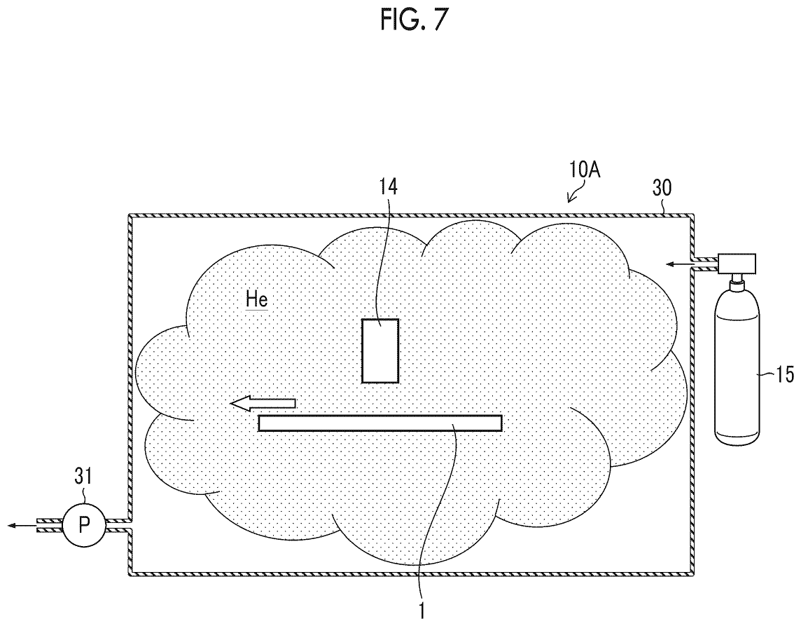

FIG. 7 is a schematic diagram showing a configuration example of a printing apparatus 10A according to the second embodiment. The printing apparatus 10A comprises a chamber 30 and an exhaust mechanism 31.

The chamber 30 houses the transport device 12 (not shown in FIG. 7) and the liquid droplet jetting head 14.

Further, the chamber 30 comprises an exhaust port (not shown) and a helium supply port (not shown). The exhaust port is connected to the exhaust mechanism 31, and the helium supply port is connected to the helium supply mechanism 15. The exhaust mechanism 31 exhausts the air inside the chamber 30 from the exhaust port and sets the internal pressure of the chamber 30 to a low vacuum (0.1 atmospheres or less) at a pressure relatively lower than the atmospheric pressure. The helium supply mechanism 15 supplies the helium from the helium supply port to the inside of the chamber 30, and sets the inside of the chamber 30 to a helium atmosphere and a pressure (1 atmosphere) to be equal to atmospheric pressure. As a result, the inside of the chamber 30 is replaced with the helium from the air.

By configuring the printing apparatus 10A in this manner, it is easy to control the flow of the helium. It should be noted that, in a case in which the gas inside the chamber 30 is replaced with the helium, it is necessary to take care that the ink is not jetted from the nozzle 202 of the liquid droplet jetting head 14 in a case in which the air inside the chamber 30 is exhausted by the exhaust mechanism 31 to bring the inside of the chamber 30 into the low vacuum state.

### Ink Tank Disposition: Third Embodiment

The ink tank that stores the ink for the circulation in the liquid droplet jetting head 14 may be inside or outside the chamber 30 filled with the helium. Here, a case will be described in which the ink tank is located inside the chamber 30.

FIG. 8 is a schematic diagram showing a configuration example of a printing apparatus 10B according to the third embodiment. The printing apparatus 10B comprises the upper ink tank 32, the lower ink tank 34, a return flow channel 36, and an ink pump 38 inside the chamber 30.

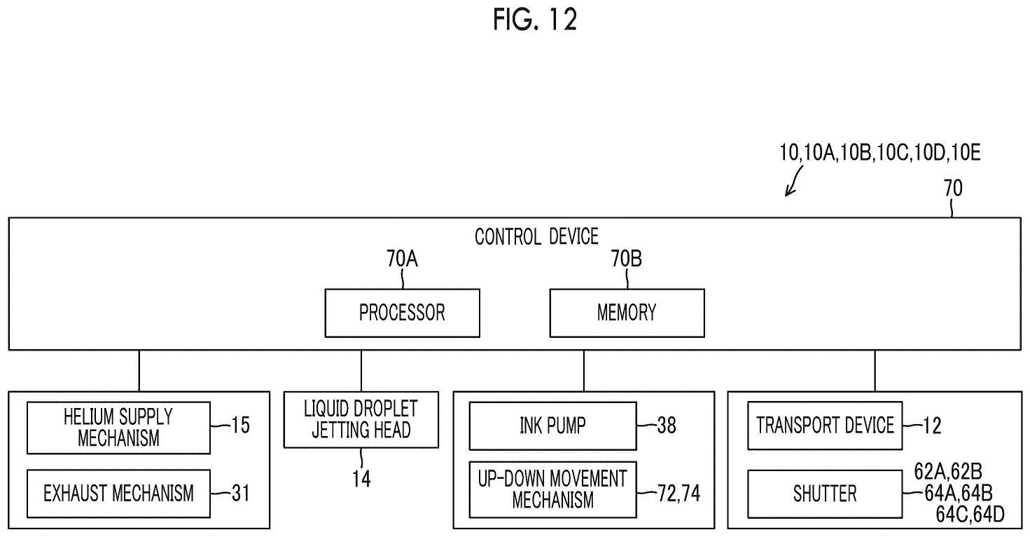

The upper ink tank 32 is a container for storing the ink to be supplied to the liquid droplet jetting head 14. The upper ink tank 32 communicates with the liquid droplet jetting head 14 via the ink supply channel 18. Further, the inside of the upper ink tank 32 is open to the atmosphere inside the chamber 30. The upper ink tank 32 is supported by a first up-down movement mechanism 72 (see FIG. 12) that is movable in a vertical direction (Z direction), and is disposed at a height at which a desired head difference is obtained.

The lower ink tank 34 is a container for storing the ink recovered from the liquid droplet jetting head 14. The lower ink tank 34 communicates with the liquid droplet jetting head 14 via the ink recovery channel 20. Further, the inside of the lower ink tank 34 is open to the atmosphere inside the chamber 30. The lower ink tank 34 is supported by a second up-down movement mechanism 74 (see FIG. 12) that is movable in the vertical direction, and is disposed at a height at which a desired head difference is obtained.

The return flow channel 36 allows the upper ink tank 32 and the lower ink tank 34 to communicate with each other. The ink pump 38, which is a liquid feed mechanism, is provided in the return flow channel 36 and feeds the ink from the lower ink tank 34 to the upper ink tank 32.

In this way, in the printing apparatus 10B, the liquid droplet jetting head 14 is disposed between the upper ink tank 32 and the lower ink tank 34. The upper ink tank 32 and the lower ink tank 34 are mechanisms that cause the ink to flow by using the head difference with gravity with respect to the liquid droplet jetting head 14 based on the pressure inside the chamber 30. In this way, a simple ink circulation configuration is obtained.

The ink circulation amount can be controlled by the first up-down movement mechanism 72 and the second up-down movement mechanism 74. In order to minimize the effect on the jetting, it is desirable that the up-down movement of the upper ink tank 32 and the lower ink tank 34 is performed at a timing at which the ink is not jetted from the liquid droplet jetting head 14.

In the printing apparatus 10B, in a case in which the air inside the chamber 30 is exhausted to be in the low vacuum state, the ink is jetted from the open regions of the upper ink tank 32 and the lower ink tank 34. In addition, the ink is jetted from the nozzle 202 of the liquid droplet jetting head 14. Therefore, it is required to close a valve (not shown) connected to the liquid droplet jetting head 14 and to close valves (not shown) at open portions of the upper ink tank 32 and the lower ink tank 34 before the air is exhausted. These valves need only be opened again after the helium is supplied to the inside of the chamber 30.

In the low vacuum state, since the pressure is applied to the tubes of the ink supply channel 18, the ink recovery channel 20, and the return flow channel 36, the upper ink tank 32, and the lower ink tank 34 to spread the ink, it is desirable not to use a material that is easily stretched, such as rubber or a soft tube.

### Solvent Evaporation Prevention: Fourth Embodiment

In order to prevent the ink solvent from being evaporated from the liquid levels of the upper ink tank 32 and the lower ink tank 34, a surface area exposed by floating a film or beads on the liquid level may be reduced.

Further, the upper ink tank 32 and the lower ink tank 34 may be closed with a soft material such as a damper membrane that can follow a change in external pressure, instead of being opened to the atmosphere inside the chamber 30. The upper ink tank 32 and the lower ink tank 34 may be configured to deform as a whole like a pouch.

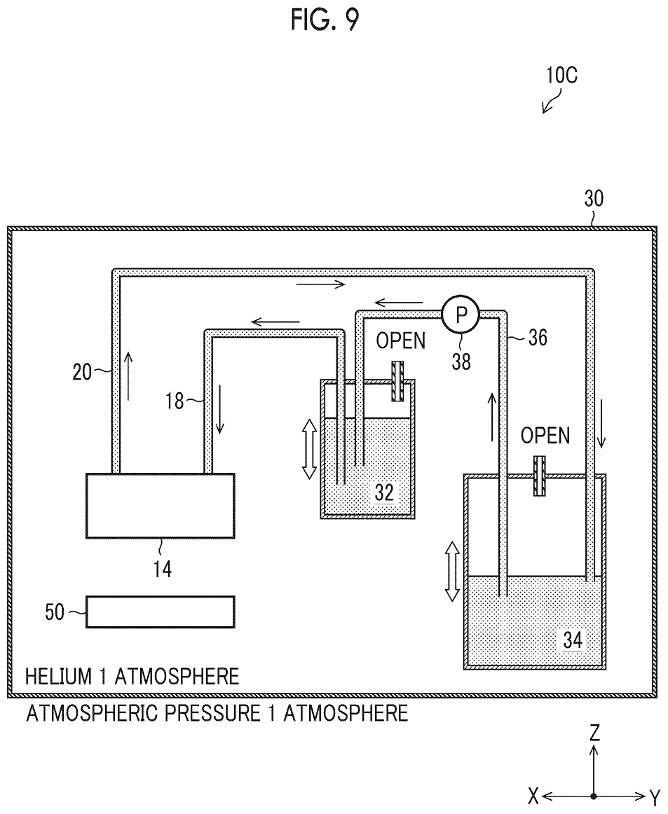

Further, in order to prevent the solvent from being evaporated from the nozzle 202 of the liquid droplet jetting head 14, only the solvent may be added in advance into the chamber 30. FIG. 9 is a schematic diagram showing a configuration example of a printing apparatus 10C according to the fourth embodiment. The printing apparatus 10C comprises a container 50 inside the chamber 30. The container 50 is disposed at a position below the liquid droplet jetting head 14 in the vertical direction. The container 50 contains the solvent (here, water) of the ink inside, and the solvent is in an open state with respect to an internal space of the chamber 30. Therefore, the solvent inside the container 50 is naturally evaporated. As a result, a partial pressure of the solvent can be increased, and the ink can be prevented from being evaporated from the nozzle 202. It goes without saying that the air resistance is affected, but there is no problem since a gas other than the main solvent is not likely to be generated.

The helium supply mechanism 15 may supply the helium containing the gas of the main solvent of the ink into the chamber 30. Further, a mechanism for supplying a gas of the main solvent of the ink may be provided separately from the helium supply mechanism 15. In these cases, since the container 50 is not necessary, the printing apparatus 10C can be configured to be compact, and the evaporation of the ink solvent from the nozzle 202 can be prevented.

It should be noted that, since the air recovered through the exhaust mechanism 31 contains the helium, it is desirable to separate helium from the recovered air and reuse the separated helium.

### Carrying-In and Carrying-Out of Substrate: Fifth Embodiment

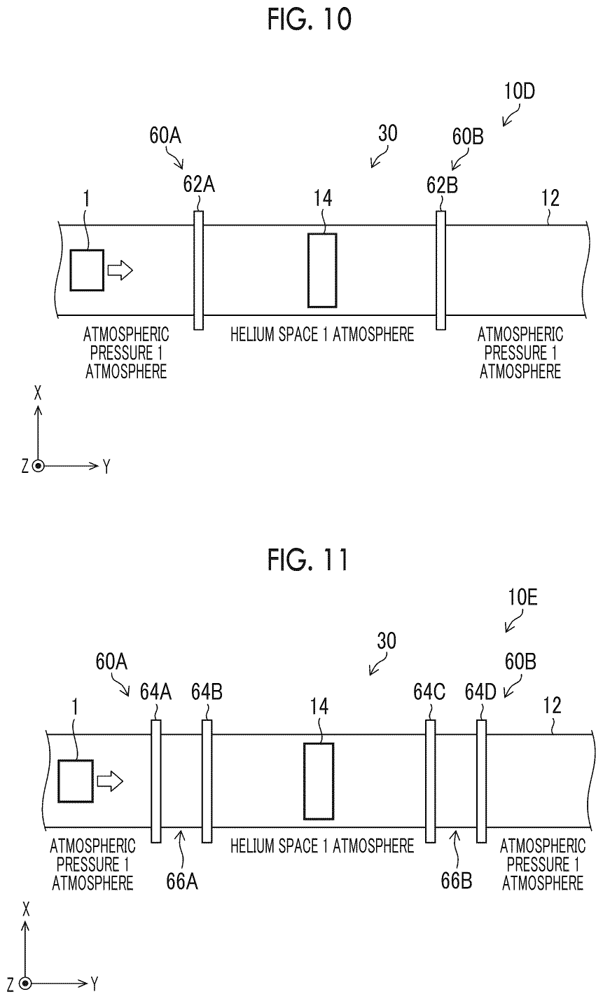

In order to reduce the loss of the helium during the carrying-in and the carrying-out of the substrate 1 as much as possible, it is desirable that the substrate 1 is taken in and out through a relatively narrow slit that can be opened and closed. FIG. 10 is a schematic diagram showing a configuration example of a printing apparatus 10D according to the fifth embodiment. The chamber 30 of the printing apparatus 10D comprises a carry-in slit 60A, a carry-out slit 60B, and a carry-in shutter 62A and a carry-out shutter 62B that are openable and closable.

The carry-in slit 60A is a slit-shaped opening portion for carrying in the substrate 1 from the outside of the chamber 30 to the inside. The carry-out slit 60B is a slit-shaped opening portion for carrying out the substrate 1 from the inside of the chamber 30 to the outside.

The carry-in shutter 62A and the carry-out shutter 62B are each disposed on a transport channel of the substrate 1 by the transport device 12. The carry-in shutter 62A is disposed in the carry-in slit 60A to open and close the carry-in slit 60A. The carry-out shutter 62B is disposed at the carry-out slit 60B to open and close the carry-out slit 60B.

In a case in which the substrate 1 outside the chamber 30 is transported into the chamber 30, the carry-in shutter 62A is opened, the substrate 1 is carried in the chamber 30 by the transport device 12, and the carry-in shutter 62A is closed.

In addition, in a case in which the substrate 1 inside the chamber 30 is transported to the outside of the chamber 30, the carry-out shutter 62B is opened, the substrate 1 is carried out of the chamber 30 by the transport device 12, and the carry-out shutter 62B is closed.

By transporting the substrate 1 as described above, it is possible to reduce the loss of the helium during the carrying-in and the carrying-out of the substrate 1.

### Carrying-In and Carrying-Out of Substrate: Sixth Embodiment

FIG. 11 is a schematic diagram showing a configuration example of a printing apparatus 10E according to the sixth embodiment. The chamber 30 of the printing apparatus 10E comprises a first shutter 64A, a second shutter 64B, a third shutter 64C, and a fourth shutter 64D that are each openable and closable.

The first shutter 64A, the second shutter 64B, the third shutter 64C, and the fourth shutter 64D are disposed on a transport channel of the substrate 1 by the transport device 12. The first shutter 64A is disposed in the carry-in slit 60A to open and close the carry-in slit 60A. The fourth shutter 64D is disposed at the carry-out slit 60B to open and close the carry-out slit 60B.

The chamber 30 includes a first adjustment chamber 66A that is a space relatively narrower than the helium space in which the liquid droplet jetting head 14 and the like inside the chamber 30 are disposed, between the first shutter 64A and the second shutter 64B. In addition, the chamber 30 includes a second adjustment chamber 66B that is a space relatively narrow with respect to the helium space inside the chamber 30, between the third shutter 64C and the fourth shutter 64D. The first adjustment chamber 66A and the second adjustment chamber 66B each comprise a vacuum pump (not shown).

The second shutter 64B switches between opening and blocking between the first adjustment chamber 66A and the helium space. The third shutter 64C switches between opening and blocking between the helium space and the second adjustment chamber 66B.

In a case in which the substrate 1 outside the chamber 30 is transported into the chamber 30, first, the first shutter 64A is opened, the substrate 1 is carried in the first adjustment chamber 66A by the transport device 12, and the first shutter 64A is closed. Next, the second shutter 64B is opened, the substrate 1 is carried in the helium space of the chamber 30 via the transport device 12, and the second shutter 64B is closed.

In addition, in a case in which the substrate 1 inside the chamber 30 is transported to the outside of the chamber 30, the third shutter 64C is opened, the substrate 1 is carried in the second adjustment chamber 66B by the transport device 12, and the third shutter 64C is closed. Next, the fourth shutter 64D is opened, the substrate 1 is carried out of the chamber 30 by the transport device 12, and the fourth shutter 64D is closed.

By transporting the substrate 1 as described above, the substrate 1 can be carried in the helium space without introducing a large amount of air into the helium space in which the liquid droplet jetting head 14 is located.

### Electric Configuration

FIG. 12 is a block diagram showing an electric configuration of the printing apparatuses 10, 10A, 10B, 10C, 10D, and 10E. The printing apparatuses 10, 10A, 10B, 10C, 10D, and 10E comprise the control device 70. The control device 70 includes a processor 70A and a memory 70B.

The processor 70A executes a command stored in the memory 70B. A hardware structure of the processor 70A is various processors as follows. Various processors include a central processing unit (CPU) as a general-purpose processor that operates as various function units by executing software (program), a graphics processing unit (GPU) as a processor specialized in image processing, a programmable logic device (PLD) as a processor of which a circuit configuration can be changed after manufacture, such as a field programmable gate array (FPGA), a dedicated electric circuit as a processor of which a circuit configuration is specifically designed to execute specific processing, such as an application-specific integrated circuit (ASIC), and the like.

One processing unit may be configured by one of these various processors, or may be configured by two or more processors of the same type or different types (for example, a plurality of FPGAs, or a combination of a CPU and an FPGA, or a combination of a CPU and a GPU). Further, a plurality of function units may be configured by one processor. As a first example in which the plurality of function units are configured by one processor, as represented by a computer such as a client or a server, there is a form in which one processor is configured by a combination of one or more CPUs and software, and this processor operates as the plurality of function units. As a second example thereof, as represented by a system-on-a-chip (SoC), there is a form in which a processor, which implements the functions of the entire system including the plurality of function units by one integrated circuit (IC) chip, is used. As described above, various function units are configured by one or more of the various processors as the hardware structure.

Further, the hardware structure of the various processors is, more specifically, an electric circuit (circuitry) in which circuit elements such as semiconductor elements are combined.

The memory 70B stores the command executed by the processor 70A. The memory 70B includes a random-access memory (RAM) and a read-only memory (ROM). The processor 70A uses the RAM as a work area, executes software using various programs and parameters stored in the ROM, and uses the parameters stored in the ROM or the like to execute various types of processing for controlling the printing apparatuses 10, 10A, 10B, 10C, 10D, and 10E.

The control device 70 controls the helium supply mechanism 15 and the exhaust mechanism 31. That is, the control device 70 reduces the pressure inside the chamber 30 via the exhaust mechanism 31 to bring the inside of the chamber 30 into, for example, the low vacuum state of 0.1 atmospheres. In addition, the control device 70 supplies the helium to the space S between the liquid droplet jetting head 14 and the substrate 1 via the helium supply mechanism 15. Further, the control device 70 performs the supply of the helium via the helium supply mechanism 15 during the non-printing, and stops the supply of the helium via the helium supply mechanism 15 during the printing.

The control device 70 controls the liquid droplet jetting head 14. That is, the control device 70 causes the nozzle 202 of the liquid droplet jetting head 14 to jet the liquid droplets I of the ink, to form an image on the substrate 1. In addition, the control device 70 applies vibration to the piezo actuator 228 of the non-jetting nozzle 202 to vibrate the meniscus of the non-jetting nozzle 202 to such an extent that the ink is not jetted during the printing.

The control device 70 controls the transport device 12, the carry-in shutter 62A, and the carry-out shutter 62B. That is, the control device 70 transports the substrate 1 in the Y direction via the transport device 12. In addition, in a case of carrying the substrate 1 in the chamber 30, the control device 70 opens and closes the carry-in shutter 62A to prevent a large amount of air from entering the helium space inside the chamber 30. Further, in a case of carrying out the substrate 1 to the outside of the chamber 30, the control device 70 opens and closes the carry-out shutter 62B to prevent a large amount of air from entering the helium space inside the chamber 30.

The control device 70 controls the transport device 12, the first shutter 64A, the second shutter 64B, the third shutter 64C, and the fourth shutter 64D. That is, the control device 70 transports the substrate 1 in the Y direction via the transport device 12. In addition, in a case in which the substrate 1 is carried in the chamber 30, the control device 70 opens and closes the first shutter 64A and the second shutter 64B in order, and prevents a large amount of air from entering the helium space inside the chamber 30. Further, in a case in which the substrate 1 is carried out of the chamber 30, the control device 70 opens and closes the third shutter 64C and the fourth shutter 64D in order, and prevents a large amount of air from entering the helium space inside the chamber 30.

The control device 70 controls the ink pump 38. That is, the control device 70 pumps the ink from the lower ink tank 34 to the upper ink tank 32 via the ink pump 38.

The control device 70 controls the first up-down movement mechanism 72 and the second up-down movement mechanism 74. That is, the control device 70 controls the circulation of the ink of the liquid droplet jetting head 14 by adjusting the position of the upper ink tank 32 in the vertical direction via the first up-down movement mechanism 72, adjusting the head difference between the upper ink tank 32 and the liquid droplet jetting head 14, adjusting the position of the lower ink tank 34 in the vertical direction via the second up-down movement mechanism 74, and adjusting the head difference between the liquid droplet jetting head 14 and the lower ink tank 34.

The control device 70 sets the circulation amount of the ink during the printing by the liquid droplet jetting head 14 to be greater than the circulation amount of the ink during the non-printing. The control device 70 stops the circulation of the ink during the non-printing.

With the printing apparatuses 10, 10A, 10B, 10C, 10D, and 10E configured as described above, it is possible to perform a manufacturing method of a printed article, the manufacturing method including supplying the helium to the space S between the liquid droplet jetting head 14 and the substrate 1, circulating the ink in the liquid droplet jetting head 14, and moving the substrate 1 and the liquid droplet jetting head 14 relative to each other via the transport device 12 and causing the liquid droplet jetting head 14 to jet the ink, to perform the printing on the substrate 1.

With the printing apparatuses 10, 10A, 10B, 10C, 10D, and 10E, since the space S between the liquid droplet jetting head 14 and the substrate 1 mainly contains the helium, the air resistance to the liquid droplets I can be reduced. In addition, by circulating the ink in the liquid droplet jetting head 14, the jetting state can be stabilized even in a case in which the solvent is evaporated from the ink.

### Others

Here, although the printing apparatus that applies the conductive ink to the print substrate has been described as the liquid droplet jetting apparatus, the substrate and the ink are not limited thereto. The liquid droplet jetting apparatus can be applied to a substrate having unevenness on a surface of paper, fabric, leather, metal, resin, glass, wood, and the like. The substrate is not limited to the substrate that is entirely housed in the chamber, and may have a long shape that extends inside and outside the chamber.

The liquid droplet jetting apparatus can apply the ink such as a color ink containing a coloring material, an ultraviolet curable ink that is cured by ultraviolet irradiation, or an insulating ink having insulating properties. The liquid droplet jetting apparatus can use a number of liquid droplet jetting heads in accordance with the type of ink, and a plurality of liquid droplet jetting heads may be disposed in one chamber, or a chamber may be provided for each liquid droplet jetting head.

The technical scope of the present invention is not limited to the scope described in the embodiments described above. The configurations and the like in the respective embodiments can be appropriately combined between the respective embodiments without departing from the gist of the present invention.

### EXPLANATION OF REFERENCES

1: substrate
10: printing apparatus
10A: printing apparatus
10B: printing apparatus
10C: printing apparatus
10D: printing apparatus
10E: printing apparatus
12: transport device
14: liquid droplet jetting head
15: helium supply mechanism
16: L-shaped bracket
18: ink supply channel
18A: ink supply port
20: ink recovery channel
20A: ink discharge port
22: filter housing
24: silicon die
30: chamber
31: exhaust mechanism
32: upper ink tank
34: lower ink tank
36: return flow channel
38: ink pump
38A: first ink pump
40: first valve
42: ink tank for replenishment
44: replenishment flow channel
46: second ink pump
48: second valve
50: container
52: control substrate
54: ASIC
56: flexible cable
60A: carry-in slit
60B: carry-out slit
62A: carry-in shutter
62B: carry-out shutter
64A: first shutter
64B: second shutter
64C: third shutter
64D: fourth shutter
66A: first adjustment chamber
66B: second adjustment chamber
70: control device
70A: processor
70B: memory
72: first up-down movement mechanism
74: second up-down movement mechanism
76: first liquid level sensor
78: second liquid level sensor
80: concentration sensor
82: solvent addition device
84: ink cooling mechanism
200: nozzle surface
202: nozzle
204: pressure chamber
206: ink chamber unit
210: supply tributary
212: common flow channel
214: descender
216: ink circulation channel
218: recovery tributary
220: circulation common flow channel
222: jetting element
226: vibration plate
228: piezo actuator
230: nozzle plate
232: flow channel plate
I: liquid droplet
S: space

What is claimed is:

1. A liquid droplet jetting apparatus comprising:
a liquid droplet jetting head that jets a liquid;
a relative movement mechanism that moves a substrate and the liquid droplet jetting head relative to each other; and
a control device that moves the substrate and the liquid droplet jetting head relative to each other and causes the liquid droplet jetting head to jet the liquid, to print an image on the substrate,
wherein a low-density gas having a lower density than air is contained between the liquid droplet jetting head and the substrate,
the liquid droplet jetting head includes a circulation flow channel inside the liquid droplet jetting head, and
the control device circulates the liquid through the circulation flow channel at least during printing.

2. The liquid droplet jetting apparatus according to claim 1,
wherein the liquid droplet jetting head includes a jetting element including a nozzle, a pressure chamber, and a jetting energy generation element, and
the circulation flow channel includes a supply flow channel for supplying the liquid to the jetting element and a recovery flow channel for recovering the liquid from the jetting element.

3. The liquid droplet jetting apparatus according to claim 1,
wherein the control device sets a circulation amount of the liquid during the printing to be greater than a circulation amount of the liquid during non-printing.

4. The liquid droplet jetting apparatus according to claim 1,
wherein the control device stops the circulation of the liquid during non-printing.

5. The liquid droplet jetting apparatus according to claim 1,
wherein the control device applies vibration to a non-jetting nozzle during the printing to an extent that the liquid droplet is not jetted.

6. The liquid droplet jetting apparatus according to claim 1, further comprising:
a supply mechanism that supplies the low-density gas between the liquid droplet jetting head and the substrate,
wherein the supply mechanism stops the supply of the low-density gas during the printing.

7. The liquid droplet jetting apparatus according to claim 1, further comprising:
a chamber that internally houses the liquid droplet jetting head and the relative movement mechanism,
wherein the chamber has a carry-in slit through which the substrate is carried in and a carry-out slit through which the substrate is carried out, the carry-in slit and the carry-out slit being each provided with an openable and closable shutter.

8. The liquid droplet jetting apparatus according to claim 1, further comprising:
a chamber that internally houses the liquid droplet jetting head and the relative movement mechanism,
wherein the liquid contains a solvent, and
the solvent is disposed inside the chamber in an open state.

9. The liquid droplet jetting apparatus according to claim 1, further comprising:
a supply mechanism that supplies the low-density gas between the liquid droplet jetting head and the substrate,
wherein the liquid contains a solvent, and
the supply mechanism supplies the low-density gas containing a gas of the solvent.

10. The liquid droplet jetting apparatus according to claim 1,
wherein the liquid is an aqueous ink containing water as a solvent.

11. A manufacturing method of a printed article, the manufacturing method comprising:
supplying a low-density gas having a lower density than air between a liquid droplet jetting head and a substrate;
moving the substrate and the liquid droplet jetting head relative to each other and causing the liquid droplet jetting head to jet a liquid, to print an image on the substrate; and
circulating the liquid through a circulation flow channel of the liquid droplet jetting head at least during printing.
